(19) United States
(12) Patent Application Publication
(10) Pub. No.: US 2024/0267643 A1
(43) Pub. Date: Aug. 8, 2024

(54) Moving Target Detection Method, Apparatus, and Device

(71) Applicant: Huawei Technologies Co., Ltd., Shenzhen (CN)

(72) Inventors: Zhipeng Deng, Shanghai (CN); Hui Hu, Shenzhen (CN)

(21) Appl. No.: 18/640,766

(22) Filed: Apr. 19, 2024

Related U.S. Application Data
(63) Continuation of application No. PCT/CN2021/125166, filed on Oct. 21, 2021.

(51) Int. Cl. H04N 25/47; G01J 1/42; H04N 9/77; H04N 25/51; H04N 25/61

(52) U.S. Cl. CPC H04N 25/47; G01J 1/42; H04N 9/77; H04N 25/51; H04N 25/61

(57) ABSTRACT

In a moving target detection method a detection apparatus controls a first pixel system to be exposed for first duration; controls a second pixel system to be exposed for second duration; obtains first luminance information and second luminance information, where the first luminance information indicates luminance obtained by exposing the first pixel system for the first duration, and the second luminance information indicates luminance obtained by exposing the second pixel system for the second duration; and generates motion information based on the first luminance information and the second luminance information, where the motion information indicates whether a difference exists between the first luminance information and the second luminance information.

### CROSS-REFERENCE TO RELATED APPLICATIONS

This is a continuation of International Patent Application No. PCT/CN2021/125166 filed on Oct. 21, 2021, the disclosure of which is hereby incorporated by reference in its entirety.

### TECHNICAL FIELD

This application relates to the signal processing field, and in particular, to a moving target detection method, apparatus, and device.

### BACKGROUND

A motion detection technology is a key technology for detecting a moving target in the intelligent surveillance field, and is the basis of moving target recognition, moving target tracking, and real-time alarm.

A frame difference algorithm is a currently widely used motion detection method, and whether a moving target exists is detected by comparing luminance differences of a same pixel in two frames of images at different moments. To implement comparison between the two frames of images, a memory needs to be disposed to store a frame of image whose time is earlier. However, when an image resolution is high, costs and device power consumption caused by image storage are high.

### SUMMARY

This application provides a moving target detection method, apparatus, and device, to reduce costs of detecting a moving target and reduce power consumption.

According to a first aspect, a moving target detection method is provided. The method may be performed by a moving target detection apparatus, and the moving target detection apparatus may be a moving target detection device, or may be a chip configured in a moving target detection device. The method includes controlling a first pixel unit to be exposed for a first duration, and controlling a second pixel unit to be exposed for a second duration, where the first duration is different from the second duration, obtaining first luminance information and second luminance information, where the first luminance information indicates luminance obtained by exposing the first pixel unit for the first duration, and the second luminance information indicates luminance obtained by exposing the second pixel unit for the second duration, and generating motion information based on the first luminance information and the second luminance information, where the motion information indicates whether a difference exists between the first luminance information and the second luminance information.

In the foregoing solution, the detection apparatus may obtain corresponding luminance information by controlling exposure duration of the first pixel unit and the second pixel unit to be different, and determine, based on the luminance information, whether a moving target exists. Therefore, subsequent corresponding processing may be performed, for example, target recognition, target tracking, and alarm prompt. Whether the moving target exists in an image acquisition frame can be detected, to reduce a detection delay of the moving target. In addition, a previous frame of image for comparison does not need to be stored. This can reduce costs and power consumption.

In a possible implementation, obtaining first luminance information and second luminance information includes controlling a first conversion unit to convert, into a first voltage value by using a first conversion gain, a charge obtained by exposing the first pixel unit for the first duration, obtaining the first luminance information, where the first luminance information is obtained based on the first voltage value, controlling a second conversion unit to convert, into a second voltage value by using a second conversion gain, a charge obtained by exposing the second pixel unit for the second duration, and obtaining the second luminance information, where the second luminance information is obtained based on the second voltage value. A ratio of the first conversion gain to the second conversion gain is a first ratio, a ratio of the first duration to the second duration is a second ratio, and the first ratio is inversely proportional to the second ratio.

In the foregoing solution, conversion gains of the first pixel unit and the second pixel unit are different. Therefore, after the detection apparatus adjusts exposure duration of the first pixel unit and the second pixel unit to be different, luminance information obtained by the detection apparatus is the same if luminance at locations at which the first pixel unit and the second pixel unit each are located does not change within an exposure time period. However, if luminance at locations at which the first pixel unit and the second pixel unit each are located changes within an exposure time period, the detection apparatus may detect, based on luminance information of the two pixel units, whether the moving target exists.

In a possible implementation, the first pixel unit and the second pixel unit are two adjacent pixel units of a same color.

In a possible implementation, a start moment of the first duration is the same as a start moment of the second duration, or an end moment of the first duration is the same as an end moment of the second duration.

In the foregoing solution, the detection apparatus may set exposure start moments to be different and exposure end moments to be the same, or may set exposure start moments to be the same and exposure end moments to be different, so that the exposure duration of the first pixel unit is different from the exposure duration of the second pixel unit. In this way, the moving target can be detected.

In a possible implementation, generating motion information based on the first luminance information and the second luminance information includes generating the motion information when a difference value between the first luminance information and the second luminance information is greater than a threshold, where the motion information indicates that the difference exists between the first luminance information and the second luminance information, or generating the motion information when a difference value between the first luminance information and the second luminance information is less than or equal to a threshold, where the motion information indicates that no difference exists between the first luminance information and the second luminance information.

In the foregoing solution, the detection apparatus may compare the difference value between the first luminance information and the second luminance information with the threshold to determine whether the moving target exists.

In a possible implementation, the first pixel unit and the second pixel unit share one microlens.

In the foregoing solution, the two pixel units used to detect the moving target share one microlens. This can eliminate interference, and reduce false detection caused by noise introduced by the two pixel units using different microlenses.

In a possible implementation, controlling a first pixel unit to be exposed for first duration, and controlling a second pixel unit to be exposed for second duration includes controlling exposure of a pixel array, where the pixel array includes the first pixel unit and the second pixel unit, and outputting first image information based on a first luminance information set corresponding to the pixel array, where the first luminance information set includes the first luminance information and the second luminance information.

In the foregoing solution, the detection apparatus may obtain, through exposure of the pixel array, the first luminance information set corresponding to the pixel array, and output the image information and generate the motion information based on the first luminance information set. The detection apparatus can detect whether the moving target exists while implementing real-time output of an image.

In a possible implementation, the method further includes, when the motion information indicates that the difference exists between the first luminance information and the second luminance information, obtaining a second luminance information set corresponding to a pixel array, and outputting second image information based on the second luminance information set.

In the foregoing solution, the detection apparatus may control exposure of the first pixel unit and the second pixel unit, to obtain the motion information. Before obtaining the motion information indicating that a luminance difference exists, the detection apparatus does not output the image information. If the motion information indicates that the difference exists between the first luminance information and the second luminance information, the detection apparatus may send first control information to a processing module. The first control information indicates the processing module to output the image information corresponding to the pixel array. In response to the first control information, the processing module outputs the second image information based on the second luminance information set corresponding to the pixel array. Therefore, the detection apparatus does not output the image information before detecting that the moving target exists, and power consumption can be reduced. When detecting that the moving target exists, the detection apparatus outputs the image information, to implement target recognition, target tracking, and the like based on the output image information.

In a possible implementation, a pixel array includes a plurality of pixel pairs, each of the pixel pairs includes two pixel units, and the first pixel unit and the second pixel unit belong to one of the pixel pairs. Controlling a first pixel unit to be exposed for first duration, and controlling a second pixel unit to be exposed for second duration includes controlling exposure of pixel units in the plurality of pixel pairs, where exposure duration of two pixel units in each of the pixel pairs is different, obtaining two pieces of luminance information of each of the plurality of pixel pairs, and generating a plurality of pieces of motion information corresponding to the plurality of pixel pairs, determining, based on the plurality of pieces of motion information, a first pixel region corresponding to a moving target in the pixel array, controlling exposure of a pixel unit in the first pixel region, and outputting third image information based on a third luminance information set corresponding to the first pixel region.

In the foregoing solution, the detection apparatus may determine a region of interest (ROI) based on the plurality of pieces of motion information, and control the processing module to output image information corresponding to the ROI, to perform subsequent processing such as target recognition or target tracking. Outputting only the image information corresponding to the ROI can reduce power consumption.

In a possible implementation, the pixel array includes a plurality of pixel pair regions, one of the pixel pair regions includes at least two of the plurality of pixel pairs, and the method further includes determining original motion information of each of the pixel pairs based on the two pieces of luminance information of each of the plurality of pixel pairs, and filtering a plurality of pieces of original motion information corresponding to the pixel pairs in one of the pixel pair regions, to obtain motion information corresponding to each pixel pair in one of the pixel pair regions.

In the foregoing solution, when a pixel pair is located at an edge of the pixel array, or the like, a false detection event may occur due to noise. The plurality of pieces of original motion information corresponding to the pixel pairs in the pixel pair region are filtered, so that noise interference can be reduced.

According to a second aspect, a moving target detection apparatus is provided. For beneficial effect, refer to the description of the first aspect. Details are not described herein again. The detection apparatus has a function of implementing a behavior in the method example in the first aspect. The function may be implemented by hardware, or may be implemented by hardware executing corresponding software. The hardware or the software includes one or more modules corresponding to the function. In an implementation, the detection apparatus includes a control module configured to control a first pixel unit to be exposed for first duration, and control a second pixel unit to be exposed for second duration, where the first duration is different from the second duration, and a motion detection module configured to obtain first luminance information and second luminance information, where the first luminance information indicates luminance obtained by exposing the first pixel unit for the first duration, and the second luminance information indicates luminance obtained by exposing the second pixel unit for the second duration. The motion detection module is further configured to output motion information based on the first luminance information and the second luminance information, where the motion information indicates whether a difference exists between the first luminance information and the second luminance information.

In a possible implementation, the apparatus includes a first conversion unit configured to convert, into a first voltage value, a charge obtained by exposing the first pixel unit for the first duration, where a conversion gain of the first conversion unit is a first conversion gain, and the first luminance information is obtained based on the first voltage value, and a second conversion unit configured to convert, into a second voltage value, a charge obtained by exposing the second pixel unit for the second duration, where a conversion gain of the second conversion unit is a second conversion gain, and the second luminance information is obtained based on the second voltage value. A ratio of the first conversion gain to the second conversion gain is a first ratio, a ratio of the first duration to the second duration is a second ratio, and the first ratio is inversely proportional to the second ratio.

In a possible implementation, the first pixel unit and the second pixel unit are two adjacent pixel units of a same color.

In a possible implementation, a start moment of the first duration is the same as a start moment of the second duration, or an end moment of the first duration is the same as an end moment of the second duration.

In a possible implementation, the motion detection module is configured to output the motion information when a difference value between the first luminance information and the second luminance information is greater than a threshold, where the motion information indicates that the difference exists between the first luminance information and the second luminance information, or the motion detection module is configured to output the motion information when a difference value between the first luminance information and the second luminance information is less than or equal to a threshold, where the motion information further indicates that no difference exists between the first luminance information and the second luminance information.

In a possible implementation, the first pixel unit and the second pixel unit share one microlens.

In a possible implementation, the apparatus includes the control module configured to control exposure of a pixel array, where the pixel array includes the first pixel unit and the second pixel unit, and a processing module configured to output first image information based on a first luminance information set, where the first luminance information set includes the first luminance information and the second luminance information.

In a possible implementation, the detection apparatus further includes a processing module. The control module is further configured to, when the motion information indicates that the difference exists between the first luminance information and the second luminance information, output first control information to the processing module, where the first control information indicates the processing module to output second image information corresponding to a pixel array, and the pixel array includes the first pixel unit and the second pixel unit, and the processing module is configured to, in response to the first control information, output the second image information based on a second luminance information set corresponding to the pixel array.

In a possible implementation, a pixel array includes a plurality of pixel pairs, each of the pixel pairs includes two pixel units, and the first pixel unit and the second pixel unit belong to one of the pixel pairs. The control module is further configured to control exposure of pixel units in the plurality of pixel pairs, where exposure duration of two pixel units in each of the pixel pairs is different, the motion detection module is configured to obtain two pieces of luminance information of each of the plurality of pixel pairs, and output a plurality of pieces of motion information corresponding to the plurality of pixel pairs, and the control module is further configured to obtain the plurality of pieces of motion information, and determine, based on the plurality of pieces of motion information, a first pixel region corresponding to a moving target in the pixel array. The detection apparatus further includes a processing module. The control module is further configured to output second control information to the processing module, where the second control information indicates the processing module to output third image information corresponding to the first pixel region, and the processing module is configured to, in response to the second control information, output the third image information based on a third luminance information set corresponding to the first pixel region.

In a possible implementation, the pixel array includes a plurality of pixel pair regions, one of the pixel pair regions includes at least two of the plurality of pixel pairs, and the motion detection module is further configured to determine original motion information of each of the pixel pairs based on the two pieces of luminance information of each of the plurality of pixel pairs, and filter a plurality of pieces of original motion information corresponding to the pixel pairs in one of the pixel pair regions, to obtain motion information corresponding to each pixel pair in one of the pixel pair regions.

According to a third aspect, a moving target detection apparatus is provided, and includes at least one processor. The at least one processor is configured to execute a program or instructions stored in a memory, so that the apparatus implements the method according to any one of the first aspect or the possible implementations of the first aspect.

Optionally, the target detection apparatus further includes the memory configured to store the program or the instructions.

According to a fourth aspect, a processor is provided, and includes an input circuit, an output circuit, and a processing circuit. The processing circuit is configured to receive a signal through the input circuit, and transmit a signal through the output circuit, so that the processor performs the method according to any one of the first aspect and the possible implementations of the first aspect.

In a specific implementation process, the processor may be one or more chips, the input circuit may be an input pin, the output circuit may be an output pin, and the processing circuit may be a transistor, a gate circuit, a trigger, any logic circuit, or the like. An input signal received by the input circuit may be received and input by, for example, but not limited to, a receiver, a signal output by the output circuit may be output to, for example, but not limited to, a transmitter and transmitted by the transmitter, and the input circuit and the output circuit may be a same circuit, where the circuit is used as the input circuit and the output circuit at different moments. Specific implementations of the processor and various circuits are not limited in this application.

According to a fifth aspect, a computer program product is provided. The computer program product includes a computer program (or a code or instructions). When the computer program is run, a computer is enabled to perform the method according to any one of the first aspect or the possible implementations of the first aspect.

According to a sixth aspect, a computer-readable storage medium is provided. The computer-readable storage medium stores a computer program (or a code or instructions). When the computer program is run on a computer, the computer is enabled to perform the method according to any one of the first aspect or the possible implementations of the first aspect.

According to a seventh aspect, an electronic device is provided. The electronic device includes the moving target detection apparatus according to the second aspect.

### BRIEF DESCRIPTION OF DRAWINGS

FIG. 1 is a schematic diagram of a structure of an electronic device to which an embodiment of this application is applicable;

FIG. 2 is a schematic diagram of an image sensor according to an embodiment of this application;

FIG. 3 is a schematic diagram of a photosensitive circuit according to an embodiment of this application;

FIG. 4 is a schematic flowchart of a moving target detection method according to an embodiment of this application;

FIG. 5 is a schematic diagram of a pixel array and a corresponding color according to an embodiment of this application;

FIG. 6 is another schematic diagram of a pixel array and a corresponding color according to an embodiment of this application;

FIG. 7 is a schematic diagram of exposure time of a first pixel unit and a second pixel unit according to an embodiment of this application;

FIG. 8 is a schematic diagram of a structure of a detection apparatus according to an embodiment of this application;

FIG. 9 is a schematic diagram of a motion detection module according to an embodiment of this application;

FIG. 10 is a schematic diagram of another structure of a detection apparatus according to an embodiment of this application;

FIG. 11 is a schematic diagram of another structure of a detection apparatus according to an embodiment of this application;

FIG. 12 is a schematic diagram of a first pixel region according to an embodiment of this application;

FIG. 13 is a schematic diagram of a correspondence between a conventional microlens and a pixel unit according to this application;

FIG. 14 is a schematic diagram of a correspondence between a microlens and a pixel unit according to an embodiment of this application;

FIG. 15 is a schematic diagram of a structure of a detection apparatus according to an embodiment of this application; and

FIG. 16 is a schematic diagram of a structure of an electronic device according to an embodiment of this application.

### DESCRIPTION OF EMBODIMENTS

To make the objectives, technical solutions, and advantages of embodiments of this application clearer, the following clearly and completely describes the technical solutions in embodiments of this application with reference to the accompanying drawings in embodiments of this application. It is clear that, the described embodiments are merely a part rather than all of embodiments of this application. All other embodiments obtained by a person of ordinary skill in the art based on embodiments of this application without creative efforts shall fall within the protection scope of this application.

In the specification, the claims, and the accompanying drawings of embodiments of this application, the terms “first”, “second”, and the like are intended to distinguish between similar objects but do not necessarily indicate a specific order or sequence. It should be understood that the data termed in such a way are interchangeable in proper circumstances so that embodiments of this application described herein can be implemented in other orders than the order illustrated or described herein. In addition, the terms “include” and “have” and any other variants are intended to cover the non-exclusive inclusion. For example, a process, method, system, product, or device that includes a list of steps or units is not necessarily limited to those expressly listed steps or units, but may include other steps or units not expressly listed or inherent to such a process, method, product, or device.

The technical solutions provided in embodiments of this application may be applied to a surveillance device in a surveillance system, a smart home device in a smart home, and a terminal device in an industrial internet or a mobile communication system, for example, a mobile phone or a tablet computer. However, this application is not limited thereto.

FIG. 1 is a schematic diagram of a structure of an electronic device to which an embodiment of this application is applicable.

As shown in FIG. 1, the electronic device 100 may include an optical component 101, an image sensor 102, and an image processor 103. The electronic device 100 may collect a light beam by using the optical component 101. For example, the optical component 101 may include a lens. The image sensor 102 may receive a photon collected by the optical component 101 and convert an optical signal into an image signal value. After the image signal value is processed by the image processor 103, the image processor 103 may output an image. It should be understood that the structural diagram of the electronic device 100 shown in FIG. 1 is merely an example provided in embodiments of this application. In an implementation, the electronic device may be divided into other different modules. For example, the image sensor 102 and the image processor 103 form a same module, or the image sensor is divided into a plurality of modules. This application is not limited thereto.

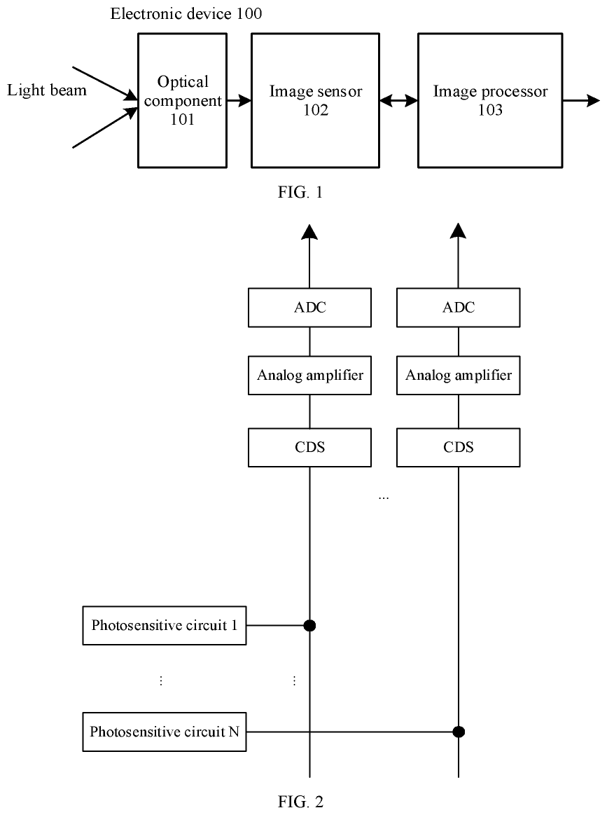

FIG. 2 is a schematic diagram of an image sensor according to an embodiment of this application. The image sensor may include a pixel array. The pixel array may be formed by photodiodes (PDs). Each photodiode belongs to a photosensitive circuit. The photosensitive circuit converts, by using the photodiode, a received photon into a charge, and then converts the charge into a voltage value of an analog signal output by the photosensitive circuit. After the voltage value passes through a correlated double sampling (CDS) unit, an analog amplifier (or analog gain) unit, and an analog-to-digital convertor (ADC), an image signal value corresponding to each pixel, for example, a grayscale value, may be output. For example, the image sensor may be a complementary metal-oxide-semiconductor (CMOS) image sensor. However, this application is not limited thereto.

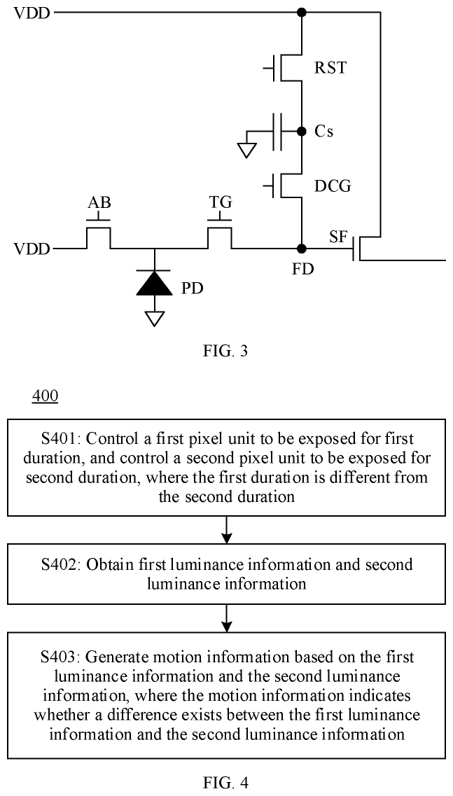

FIG. 3 is a schematic diagram of a photosensitive circuit according to an embodiment of this application. The photosensitive circuit includes a transfer gate (TG), a reset (RST) transistor (denoted as RST in FIG. 3), a source follower (SF), a floating diffusion (FD) node, a double conversion gain (DCG) metal-oxide-semiconductor (MOS) transistor (denoted as DCG in FIG. 3), a capacitor storage (Cs), and an anti-blooming (AB) MOS transistor (denoted as AB in FIG. 3). FIG. 3 is merely a schematic diagram of the photosensitive circuit according to an embodiment of this application. The photosensitive circuit may further include a color filter array disposed in front of a pixel array, and a microlens disposed in front of the color filter array. A surface area of the microlens determines a photosensitive area, and the microlens can improve photosensibility of a pixel unit.

When the photosensitive circuit works, first, the RST is controlled to be turned on, so that the capacitor storage Cs is connected to a power supply end. The capacitor storage Cs releases a stored charge. Then, the RST is turned off, and the TG is turned on, so that a PD starts exposure to convert a photon into a charge, and the charge is sent to the capacitor storage Cs. The capacitor storage Cs accumulates charges from the PD. After exposure ends, an output voltage value U of the capacitor storage Cs is a ratio of the accumulated stored charge amount Q to a capacitance C of the capacitor storage Cs, and is denoted as U=Q/C. Therefore, it can be learned that a conversion gain of converting the charge amount into the voltage value by the capacitor storage Cs is 1/C. A DCG may change a conversion gain of the capacitor storage Cs. Therefore, in a low luminance condition, the conversion gain of the capacitor storage Cs can be increased by using a small capacitance, to improve detection sensitivity, or in a high luminance condition, the conversion gain can be decreased by using a large capacitance, to improve a dynamic range of detection.

For problems of costs and power consumption caused by disposing a memory to store image frames in a current frame difference algorithm, this application provides solutions in which two pixel units in a pixel array may be controlled to be exposed for different duration, and whether a moving target exists may be determined based on luminance information of the two pixel units obtained after exposure. This can detect whether the moving target exists in an image frame, reduce a detection delay of the moving target, and reduce costs and power consumption.

The following describes a moving target detection method provided in embodiments of this application with reference to the accompanying drawings.

FIG. 4 is a schematic flowchart of a moving target detection method according to an embodiment of this application.

The moving target detection method shown in FIG. 4 may be performed by a moving target detection apparatus. The detection apparatus may be an electronic device configured to detect a moving target. Alternatively, the detection apparatus may be configured in an electronic device. For example, the moving target detection apparatus may be a chip. The electronic device includes a pixel array, and the pixel array includes a plurality of pixel units. The method includes but is not limited to the following steps.

S401: The detection apparatus controls a first pixel unit to be exposed for first duration, and controls a second pixel unit to be exposed for second duration, where the first duration is different from the second duration.

The first pixel unit and the second pixel unit are two pixel units in the pixel array of the electronic device, and the first pixel unit and the second pixel unit may be referred to as a pixel pair.

Optionally, the first pixel unit and the second pixel unit may be two adjacent pixel units of a same color.

Two adjacent pixel units may be considered to receive photons at a same environment location, and the two pixel units are controlled to be exposed for different duration, so that the detection apparatus can determine, based on luminance information obtained by exposing the two pixel units, whether a luminance change occurs at the location (or region) at which/in which the pixel pair is located, and determine whether the moving target exists at the location (or region).

For example, in an 8×8 pixel array of eight rows and eight columns shown in FIG. 5, R represents a red pixel unit, G represents a green pixel unit, B represents a blue pixel unit, and W represents a white pixel unit. The first pixel unit and the second pixel unit may be two diagonally adjacent pixel units of a same color in a same 2×2 pixel unit block. For example, in a 2×2 pixel unit block in which the first column and the second column intersect with the first row and the second row shown in FIG. 5, the first pixel unit and the second pixel unit may be two red pixel units R1 and R2 that are diagonally adjacent, or the first pixel unit and the second pixel unit may be two white pixel units W1 and W2 that are diagonally adjacent. Alternatively, the first pixel unit and the second pixel unit may be two green pixel units G1 and G2 that are diagonally adjacent, or two blue pixel units B1 and B2 that are diagonally adjacent. This is not limited in this application.

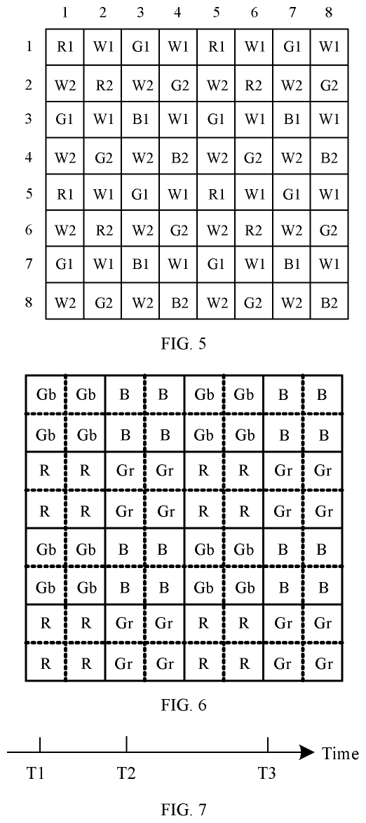

For another example, in an 8×8 pixel array of eight rows and eight columns shown in FIG. 6, pixel units in one 2×2 pixel unit block have a same color, and may be green light Gb or Gr, blue light B, or red light R. The first pixel unit and the second pixel unit may be any two pixel units of a same color in a 2×2 pixel unit block, for example, two pixel units that are left and right adjacent, top and bottom adjacent, or diagonally adjacent.

It should be noted that the foregoing two examples are preferable solutions provided in embodiments of this application, but this application is not limited thereto. In an implementation, two adjacent pixel units in the pixel array may be selected. For example, one or more pixel units may be spaced between the first pixel unit and the second pixel unit, and detection of the moving target by using the solution provided in this embodiment of this application also falls within the protection scope of this application.

Optionally, a start moment of the first duration is the same as a start moment of the second duration, or an end moment of the first duration is the same as an end moment of the second duration.

For example, the detection apparatus may control both the first pixel unit and the second pixel unit to start to be exposed at a moment T1 shown in FIG. 7, the second pixel unit to stop being exposed at a moment T2, and the first pixel unit to stop being exposed at a moment T3. In this case, the first duration is T3−T1, and the second duration is T2−T1. The detection apparatus may obtain luminance information obtained by exposing the first pixel unit for the first duration, and luminance information obtained by exposing the second pixel unit for the second duration.

For another example, the detection apparatus may control the first pixel unit to start to be exposed at a moment T1 shown in FIG. 7, control the second pixel unit to start to be exposed at a moment T2 shown in FIG. 7, and control both the first pixel unit and the second pixel unit to stop being exposed at a moment T3. In this case, the first duration is T3−T1, and the second duration is T3−T2. The detection apparatus may obtain luminance information obtained by exposing the first pixel unit for the first duration, and luminance information obtained by exposing the second pixel unit for the second duration.

In an implementation, a time sequence processing manner when the start moment of the first duration is the same as the start moment of the second duration is different from that when the end moment of the first duration is the same as the end moment of the second duration. For example, when the start moment of the first duration is the same as the start moment of the second duration, and the first duration is greater than the second duration, after the second duration ends, the detection apparatus may obtain the luminance information obtained by exposing the second pixel unit for the second duration, need to wait for the end of the first duration to obtain the luminance information obtained by exposing the first pixel unit for the first duration, and generate motion information based on luminance information corresponding to the two pixel units. When the end moment of the first duration is the same as the end moment of the second duration, the detection apparatus may obtain corresponding luminance information and generate motion information after exposure of the two pixel units ends at the same time. A time sequence design is simpler when exposure of the two pixels ends at the same time. It should be understood that the start moments and the end moments of the first duration and the second duration may alternatively be different. For example, the second duration belongs to a time period within the first duration, and motion detection can also be implemented based on the solution provided in this embodiment of this application. This is not limited in this application.

S402: The detection apparatus obtains first luminance information and second luminance information.

The first luminance information indicates luminance obtained by exposing the first pixel unit for the first duration, and the second luminance information indicates luminance obtained by exposing the second pixel unit for the second duration.

Optionally, the detection apparatus may control a first conversion unit to convert, into a first voltage value by using a first conversion gain, a charge obtained by exposing the first pixel unit for the first duration, and obtain the first luminance information, where the first luminance information is obtained based on the first voltage value. The detection apparatus controls a second conversion unit to convert, into a second voltage value by using a second conversion gain, a charge obtained by exposing the second pixel unit for the second duration, and obtains the second luminance information, where the second luminance information is obtained based on the second voltage value. A ratio of the first conversion gain to the second conversion gain is a first ratio, a ratio of the first duration to the second duration is a second ratio, and the first ratio is inversely proportional to the second ratio.

It should be noted that, that the conversion unit converts a charge into a voltage value may be understood as that the conversion unit outputs an analog signal after obtaining a charge obtained by exposing a pixel unit, and a voltage value of the analog signal is the voltage value obtained by the conversion unit through conversion. In addition, that the luminance information is obtained based on the voltage value. In an implementation, the luminance information may be the voltage value output by the conversion unit, that is, the first voltage value represents the first luminance information, and the second voltage value represents the second luminance information. Alternatively, the luminance information may be obtained by processing the voltage value of the conversion unit by another unit/module. This is not limited in this application.

The detection apparatus adjusts, based on different conversion gains corresponding to the first pixel unit and the second pixel unit, exposure duration of the first pixel unit and the second pixel unit to be different. When luminance at locations at which the first pixel unit and the second pixel unit each are located does not change, obtained luminance information is the same. However, when luminance at locations at which the first pixel unit and the second pixel unit each are located changes within an exposure time period, obtained luminance information is different, so that the detection apparatus can detect, based on the luminance information of the two pixel units, whether the moving target exists.

For example, the first duration is greater than the second duration, that is, exposure time of the first pixel unit is longer than exposure time of the second pixel unit. When luminance at a location at which the pixel pair is located does not change within the first duration, a charge amount Q1 output by the first pixel unit is greater than a charge amount Q2 output by the second pixel unit, and when a ratio of the first duration to the second duration is a second ratio a, Q1/Q2=a. The first conversion unit converts the charge amount Q1 into the first voltage value U1 by using the first conversion gain 1/C1, that is, U1=Q1/C1, and the second conversion unit converts the charge amount Q2 into the second voltage value U2 by using the second conversion gain 1/C2. Because the conversion gain ratio is inversely proportional to the duration ratio, the ratio of 1/C1 to 1/C2 is 1/a, and U1=U2. The first luminance information obtained by the detection apparatus based on U1 is the same as the second luminance information obtained based on U2. Therefore, it can be determined that no moving target exists. When luminance at a location at which the pixel pair is located changes within the first duration, voltage values output by the first conversion unit and the second conversion unit are different, so that the detection apparatus can obtain different luminance information based on different exposure duration of the two pixel units, thereby determining whether the moving target exists.

For example, the conversion unit may include the capacitor storage Cs and the DCG that are in the photosensitive circuit shown in FIG. 3 and that are configured to store a charge. The detection apparatus may control the DCG to adjust a conversion gain of the capacitor storage Cs. For example, the detection apparatus controls a first DCG in a photosensitive circuit of the first pixel unit, so that a conversion gain of a first capacitor storage corresponding to the first pixel unit is a first conversion gain. The first capacitor storage is configured to store a charge output by the first pixel unit. The detection apparatus controls a second DCG in a photosensitive circuit of the second pixel unit to adjust a conversion gain of a second capacitor storage corresponding to the second pixel unit to a second conversion gain. The second capacitor storage is configured to store a charge output by the second pixel unit. However, this application is not limited thereto. The conversion unit may further include a CDS unit and/or an analog amplifier unit connected to the photosensitive circuit.

Optionally, the detection apparatus may further increase or decrease the voltage value of the output signal based on an algorithm. In this way, when luminance does not change, luminance information of the two pixel units is the same, and when luminance changes, luminance information of the two pixel units is different.

For example, conversion gains of the first conversion unit and the second conversion unit may be the same. The detection apparatus may obtain a voltage value obtained by the first conversion unit after the first pixel unit is exposed for the first duration, obtain a first voltage value by decreasing the voltage value to 1/a based on the algorithm, obtain the first luminance information based on the first voltage value, and then obtain the second luminance information based on a second voltage value obtained by the second conversion unit after the second pixel unit is exposed for the second duration. Therefore, when luminance does not change, the two pieces of luminance information is the same.

For another example, conversion gains of the first conversion unit and the second conversion unit may be the same, and the detection apparatus may obtain the first luminance information based on a first voltage value obtained by the first conversion unit after the first pixel unit is exposed for the first duration. After obtaining the voltage value obtained by the first conversion unit after the first pixel unit is exposed for the first duration, the detection apparatus increases, based on the algorithm, the voltage value by a times to obtain a second voltage value, and obtains the second luminance information based on the second voltage value. Therefore, when luminance does not change, the two pieces of luminance information is the same.

S403: The detection apparatus generates motion information based on the first luminance information and the second luminance information, where the motion information indicates whether a difference exists between the first luminance information and the second luminance information.

The first luminance information may be a first luminance value obtained by exposing the first pixel unit for the first duration, and the second luminance information may be a second luminance value obtained by exposing the second pixel unit for the second duration.

Optionally, that the detection apparatus generates motion information based on the first luminance information and the second luminance information includes generating the motion information when a difference value between the first luminance information and the second luminance information is greater than a threshold, where the motion information indicates that the difference exists between the first luminance information and the second luminance information.

When the difference value between the first luminance information and the second luminance information is greater than the threshold, it may be considered that the moving target exists, and the output motion information indicates that the difference exists between the first luminance information and the second luminance information, or the motion information indicates that the moving target exists. This may include but is not limited to the following two implementations.

Implementation 1: The detection apparatus may calculate a difference between the first luminance value and the second luminance value, that is, the difference value. The detection apparatus compares the difference value with a preset threshold, and generates motion information if the difference value is greater than the preset threshold, where the motion information indicates the difference exists between the first luminance information and the second luminance information.

Implementation 2: The detection apparatus may preset two thresholds, for example, a first threshold and a second threshold, where the first threshold is a positive number, and the second threshold is a negative number. Generating the motion information when a difference value between the first luminance information and the second luminance information is greater than a threshold includes the following. The detection apparatus generates first motion information if the difference between the first luminance value and the second luminance value is greater than the first threshold, where the first motion information indicates that the difference between the first luminance value and the second luminance value is greater than the first threshold, or the detection apparatus generates second motion information if the difference between the first luminance value and the second luminance value is less than the second threshold, where the second motion information indicates that the difference between the first luminance value and the second luminance value is less than the second threshold.

In Implementation 2, the motion information generated by the detection apparatus indicates whether environment luminance changes from bright to dark or from dark to bright within the first duration.

For example, the first duration is greater than the second duration, and an end moment of the first duration is the same as an end moment of the second duration, that is, an exposure start moment of the second pixel unit is later than an exposure start moment of the first pixel unit. The detection apparatus may preset a first threshold T₁ and a second threshold T₂, where T₁ is a positive number, and T₂ is a negative number. The detection apparatus calculates a difference I_{diff} between the first luminance value I₁ and the second luminance value I₂, where I_{diff}−I₁−I₂.

If I_{diff}>T₁, that is, I₁>I₂, and I_{diff} is greater than T₁, it indicates that luminance of an environment in which the first pixel unit and the second pixel unit are located changes from bright to dark within the first duration. Therefore, it is considered that a negative event occurs, and motion information may be generated to indicate that the negative event occurs. For example, a pulse signal corresponding to −1 is generated as the motion information.

Alternatively, if I_{diff}<T₂, that is, I₁<I₂, I_{diff} is a negative number, and I_{diff} is less than T₂, it indicates that luminance of an environment in which the first pixel unit and the second pixel unit are located changes from dark to bright within the first duration. Therefore, it is considered that a positive event occurs, and motion information may be generated to indicate that the positive event occurs. For example, a pulse signal corresponding to 1 is generated as the motion information.

For another example, the first duration is greater than the second duration, and a start moment of the first duration is the same as a start moment of the second duration, that is, an exposure end moment of the second pixel unit is earlier than an exposure end moment of the first pixel unit. The detection apparatus may preset a first threshold T₁ and a second threshold T₂, where T₁ is a positive number, and T₂ is a negative number. The detection apparatus calculates a difference I_{diff} between the first luminance value I₁ and the second luminance value I₂, where I_{diff}=I₁−I₂.

If I_{diff}>T₁, it indicates that luminance of an environment in which the first pixel unit and the second pixel unit are located changes from dark to bright within the first duration. Therefore, it is considered that a positive event occurs, and motion information may be generated to indicate that the positive event occurs. For example, a pulse signal corresponding to 1 is generated as the motion information.

Alternatively, if I_{diff}<T₂, it indicates that luminance of an environment in which the first pixel unit and the second pixel unit are located changes from bright to dark within the first duration. Therefore, it is considered that a negative event occurs, and motion information may be generated to indicate that the negative event occurs. For example, a pulse signal corresponding to −1 is generated as the motion information.

Optionally, the first voltage value may represent the first luminance value, and the second voltage value may represent the second luminance value. That is, the first voltage value may correspond to the first luminance value, and the second voltage value may correspond to the second luminance value.

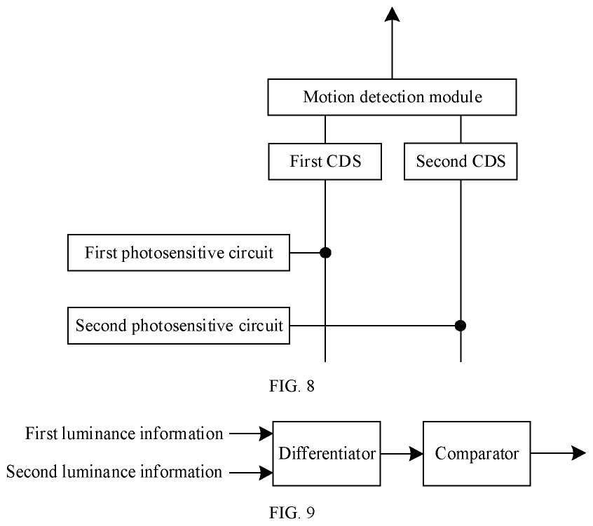

For example, as shown in FIG. 8, the first voltage value may be a voltage value of a signal that is output after an output signal of a first photosensitive circuit in which the first pixel unit is located is processed by a first CDS unit, that is, the first conversion unit may include the first CDS unit, and a conversion gain of the first conversion unit is a first conversion gain. The second voltage value may be a voltage value of a signal that is output after an output signal of a second photosensitive circuit in which the second pixel unit is located is processed by a second CDS unit, that is, the second conversion unit includes the second CDS unit, and a conversion gain of the second conversion unit is a first conversion gain. A motion detection module may generate motion information based on the first voltage value of the output signal of the first CDS unit and the second voltage value of the output signal of the second CDS unit. However, this application is not limited thereto. Refer to the structure shown in FIG. 2. The first voltage value may alternatively be a voltage value of a signal output by the analog amplifier unit behind the first CDS unit, and the second voltage value may be a voltage value of a signal output by the analog amplifier unit behind the second CDS unit.

Alternatively, when conversion gains of the first conversion unit and the second conversion unit are the same, the first voltage value may be obtained by the foregoing detection apparatus based on an algorithm, or the second voltage value may be obtained by the foregoing detection apparatus based on an algorithm.

Optionally, refer to the structure shown in FIG. 2. The first luminance value may be a grayscale value obtained after an output signal of a photosensitive circuit in which the first pixel unit is located is processed by the CDS unit, the analog amplifier unit, and the ADC unit. Correspondingly, the second luminance value may be a grayscale value output by the ADC unit corresponding to the second pixel unit. However, this application is not limited thereto.

For example, the detection apparatus may further output the motion information by using the motion detection module based on the first luminance information and the second luminance information. A structure of the motion detection module includes a differentiator and a comparator shown in FIG. 9. After the first luminance information and the second luminance information are input into the differentiator, the differentiator outputs a difference value between the first luminance information and the second luminance information, and the comparator compares the difference value with a threshold, and outputs the motion information. Optionally, the first luminance information may be a first voltage value, the second luminance information may be a second voltage value, and input of the differentiator may be a signal having the first voltage value output by the first CDS unit shown in FIG. 8, and a signal having the second voltage value output by the second CDS unit shown in FIG. 8.

In an implementation, when the difference between the first luminance information and the second luminance information is less than or equal to the threshold, the detection apparatus may not generate the motion information.

In another implementation, when the difference value between the first luminance information and the second luminance information is less than or equal to the threshold, the motion information is generated, where the motion information indicates that no difference exists between the first luminance information and the second luminance information.

For example, the difference value is a difference between the first luminance value and the second luminance value. In the foregoing implementation 2, that a difference value between the first luminance information and the second luminance information is less than or equal to a threshold includes the following. The difference between the first luminance value and the second luminance value is less than or equal to the first threshold, or the difference between the first luminance value and the second luminance value is greater than or equal to the second threshold. That is, T₂≤I_{diff}<T₁.

According to the foregoing solution, the detection apparatus may obtain corresponding luminance information by controlling exposure duration of the first pixel unit and the second pixel unit to be different, and determine, based on the luminance information, whether the moving target exists. Therefore, subsequent corresponding processing may be performed, for example, target recognition, target tracking, and alarm prompt. Whether the moving target exists in an image frame can be detected, to reduce a detection delay of the moving target. In addition, a previous frame of image for comparison does not need to be stored. This can reduce costs and power consumption.

In the method provided in this embodiment of this application, when controlling a processing module to output image information in real time, the detection apparatus may determine, based on the first luminance information and the second luminance information, whether the moving target exists. The detection apparatus may alternatively detect the moving target, and control the processing module not to output the image information when no moving target exists. When determining, based on the motion information, that the moving target exists, the detection apparatus may control the processing module to output the image information. This may include but is not limited to the following implementations.

In an implementation, that the detection apparatus controls a first pixel unit to be exposed for first duration, and controls a second pixel unit to be exposed for second duration includes the following. The detection apparatus controls exposure of a pixel array, where the first pixel unit is exposed for the first duration, and the second pixel unit is exposed for the second duration. The detection apparatus may output the motion information based on the first luminance information and the second luminance information, and the detection apparatus may further control the processing module to output first image information based on a first luminance information set corresponding to the pixel array. The first luminance information set includes the first luminance information and the second luminance information.

That is, the detection apparatus may obtain, through exposure of the pixel array, the luminance information set corresponding to the pixel array, and output the image information and generate the motion information based on the luminance information set.

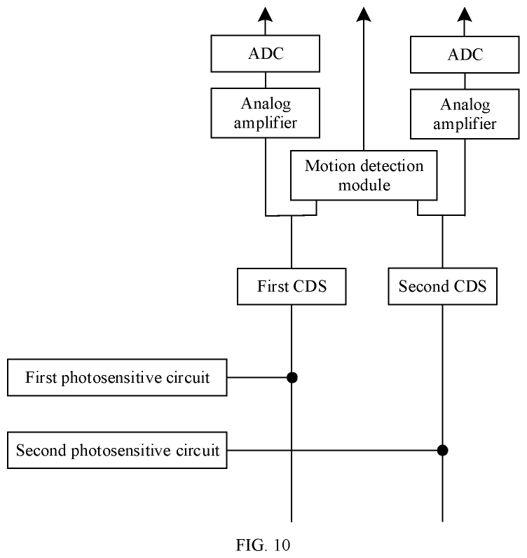

For example, as shown in FIG. 10, after an output signal of a first photosensitive circuit is processed by the first CDS unit, one channel of the first luminance information output by the CDS unit enters the motion detection module, and is used to generate the motion information to detect whether the moving target exists. After the other channel of the first luminance information passes through the analog amplifier unit and the ADC unit, a first image signal value corresponding to the first pixel unit is obtained. Similarly, one channel of the second luminance information output by the second CDS unit enters the motion detection module. After the other channel of the second luminance information passes through the analog amplifier unit and the ADC unit, a second image signal value corresponding to the second pixel unit is obtained. The first image information includes the first image signal value, the second image signal value, and an image signal value corresponding to another pixel in the pixel array. The processing module may include the analog amplifier unit and the ADC unit. However, this application is not limited thereto.

Optionally, the pixel array includes a plurality of pixel pairs, each of the pixel pairs includes two pixel units, and the first pixel unit and the second pixel unit belong to one of the pixel pairs. The detection apparatus may obtain two pieces of luminance information based on different exposure duration of two pixel units in each of the plurality of pixel pairs, and generate motion information corresponding to the pixel pair, to obtain a plurality of pieces of motion information corresponding to the plurality of pixel pairs.

For example, in the pixel array shown in FIG. 5, W1 and W2 in each 2×2 pixel unit block are one pixel pair, and the pixel array includes 16 pixel pairs in total. Alternatively, in the pixel array shown in FIG. 5, R1 and R2 in the 2×2 pixel unit block including R1 and R2 are one pixel pair, the pixel array includes four pixel pairs in total, and four pieces of motion information may be generated based on the four pixel pairs.

For an exposure manner of two pixel units in each pixel pair and a manner of generating the motion information, refer to the first pixel unit and the second pixel unit. For brevity, details are not described herein again. The detection apparatus may obtain the plurality of pieces of motion information based on the plurality of pixel pairs, and determine whether the moving target exists, and may further perform target recognition, target tracking, or the like based on the plurality of pieces of motion information.

In another implementation, when the motion information indicates that the difference exists between the first luminance information and the second luminance information, the detection apparatus sends first control information to the processing module. The first control information indicates the processing module to output the image information corresponding to the pixel array. In response to the first control information, the processing module outputs the second image information, where the second image information is obtained by the processing module based on the second luminance information set.

That is, the detection apparatus may control exposure of the first pixel unit and the second pixel unit, to obtain the motion information. Before obtaining the motion information indicating that a luminance difference exists, the detection apparatus does not output the image information. If the motion information indicates that the difference exists between the first luminance information and the second luminance information, the detection apparatus may send first control information to the processing module. The first control information indicates the processing module to output the image information corresponding to the pixel array. In response to the first control information, the processing module outputs the second image information based on the second luminance information set corresponding to the pixel array.

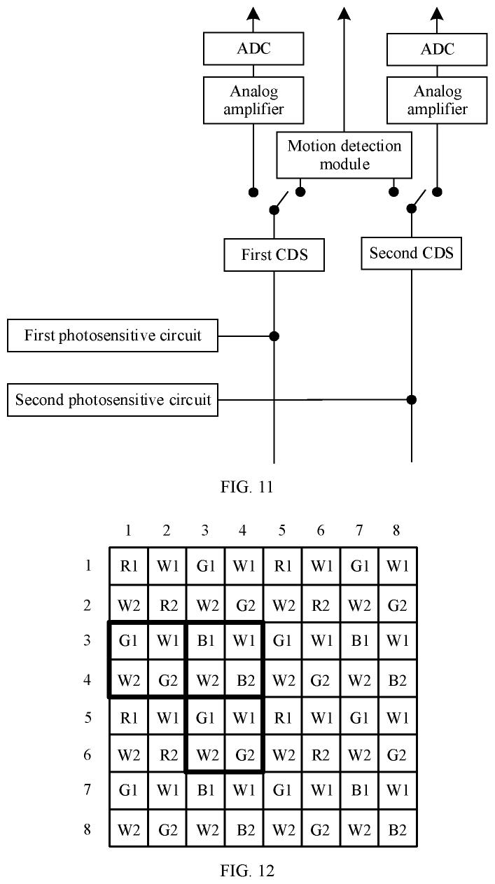

For example, as shown in FIG. 11, an output end of the CDS unit may be connected to a switching circuit. The detection apparatus may control the first CDS unit and the second CDS unit to be respectively connected to the motion detection module. The first luminance information and the second luminance information that are respectively output by the first CDS unit and the second CDS unit are input to the motion detection module, to generate the motion information. In this case, the processing module does not output the image information. If the motion information indicates that the difference exists between the first luminance information and the second luminance information, the detection apparatus may control the first CDS unit and the second CDS unit to be respectively connected to corresponding analog amplifier units. After luminance information output by each CDS unit passes through the analog amplifier unit and the ADC unit, an image signal value corresponding to the pixel unit is output. The processing module may include an analog amplifier unit and an ADC unit corresponding to each photosensitive circuit. The detection apparatus may control, based on the first control information, each CDS unit to be connected to a corresponding analog amplifier unit. In response to the first control information, the processing module obtains luminance information output by each CDS unit, to obtain a second luminance information set, and outputs second image information, where the second image information includes an image signal value corresponding to a pixel unit in the pixel array. If no difference exists between the first luminance information and the second luminance information, for example, the motion detection module determines that no difference exists and does not output the motion information, or the motion information is output to indicate that no difference exists, the detection apparatus may continue to perform moving target detection, and the processing module does not output the image information. This manner may be applied to a surveillance scenario. When the detection apparatus determines that no moving target exists, image information is not output for subsequent image processing, display, and the like. This can reduce power consumption.

Optionally, the pixel array includes a plurality of pixel pairs for moving target detection. In this implementation, the detection apparatus may determine, based on one or more of a plurality of pieces of motion information corresponding to the plurality of pixel pairs, whether to control the processing apparatus to output the image information.

Optionally, the detection apparatus may determine a first pixel region in the pixel array based on the plurality of pieces of motion information corresponding to the plurality of pixel pairs, and the detection apparatus may send second control information to the processing module. The second control information indicates the processing module to output image information corresponding to the first pixel region. In response to the second control information, the processing module outputs third image information based on a third luminance information set.

The first pixel region may be referred to as an ROI.

For example, in the pixel array shown in FIG. 12, W1 and W2 in each 2×2 pixel unit block are one pixel pair, and the pixel array includes 16 pixel pairs in total. The detection apparatus obtains a plurality of pieces of motion information based on the plurality of pieces of pixel pairs. In pixel pairs in rows 3 and 4 of columns 1 and 2, pixel pairs in rows 3 and 4 of columns 3 and 4, and pixel pairs in rows 5 and 6 of columns 3 and 4 in the pixel array, motion information that is in the plurality of pieces of motion information and that corresponds to the three pixel pairs indicates that a moving target exists (that is, a difference exists between two pieces of luminance information obtained based on the pixel pairs). The detection apparatus may determine, in the pixel array based on the three pieces of motion information, a first pixel region corresponding to the moving target, to control the processing module to output image information of the first pixel region. For example, the detection apparatus may determine that rows 3, 4, 5, and 6 of columns 1, 2, 3, and 4 in the pixel array are the first pixel region, or the detection apparatus may determine that rows 1 to 8 of columns 1 to 6 are the first pixel region, and control the processing module to output the image information of the first pixel region. A specific manner in which the detection apparatus determines the pixel region based on the motion information may be specified based on a requirement in a specific implementation. This is not limited in this application.

According to the foregoing solution, the detection apparatus may determine an ROI based on the plurality of pieces of motion information, and control the processing module to output image information corresponding to the ROI, to perform subsequent processing such as target recognition or target tracking. Outputting only the image information corresponding to the ROI can reduce power consumption.

According to the foregoing moving target detection method provided in this embodiment of this application, the moving target can be detected. However, in a low probability case, for example, when a pixel pair is located at an edge of the pixel array, a false detection event may occur due to noise. This embodiment of this application further provides the following interference elimination manner, but this application is not limited thereto.

Manner 1: After obtaining original motion information of each of the plurality of pixel pairs according to the foregoing method, the detection apparatus filters a plurality of pieces of original motion information.

Optionally, the detection apparatus may perform median filtering on the plurality of pieces of original motion information.

Further, the pixel array may include a plurality of pixel pair regions, and one pixel pair region includes at least two pixel pairs. The detection apparatus may perform median filtering on the plurality of pieces of original motion information corresponding to one pixel pair region, to obtain motion information corresponding to each pixel pair in one pixel pair region.

For example, one pixel pair region may include at least nine pixel pairs. For example, one pixel pair region includes nine pixel pairs. The detection apparatus may filter nine pieces of original motion information corresponding to one pixel pair region by using a 3×3 filter, to obtain filtered motion information corresponding to each pixel pair. Optionally, the filter may perform filtering in a median filtering manner.

For another example, in the pixel array shown in FIG. 5, W1 and W2 in each 2×2 pixel unit block are one pixel pair, and it may be specified that a 4×4 pixel unit block is one pixel pair region. The pixel array shown in FIG. 5 includes four pixel pair regions in total. For example, rows 1 to 4 of columns 1 to 4 are one pixel pair region, rows 5 to 8 of columns 1 to 4 are one pixel pair region, rows 1 to 4 of columns 5 to 8 are one pixel pair region, rows 5 to 8 of columns 5 to 8 are one pixel pair region, and each pixel pair region includes four pixel pairs. After obtaining the original motion information corresponding to each pixel pair, the detection apparatus performs median filtering on the four pieces of original motion information obtained from each pixel pair region, to obtain filtered motion information corresponding to each pixel pair.

Manner 2: The first pixel unit and the second pixel unit share one microlens. When the pixel array includes a plurality of pixel pairs, two pixel units in a same pixel pair share one microlens.

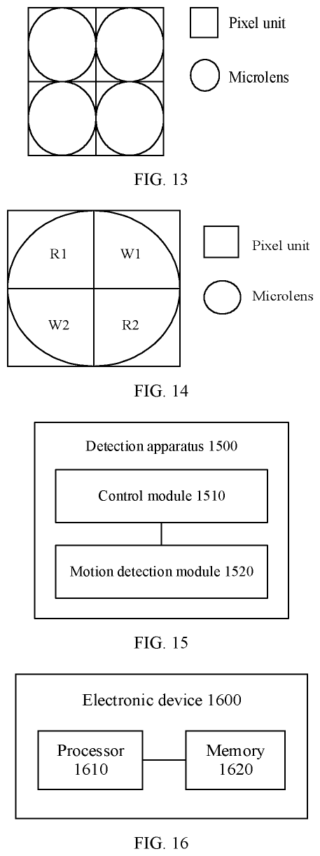

Each pixel unit in the pixel array may receive a photon by using the microlens, to improve photosensibility of the pixel unit. In a conventional manner, FIG. 13 shows a 2×2 pixel unit block, including four pixel units. Each pixel unit corresponds to one microlens, and one pixel unit passes through a corresponding microlens. According to this embodiment of this application, two pixel units in a same pixel pair may share one microlens. For example, as shown in FIG. 14, W1 and W2 in a 2×2 pixel unit block are one pixel pair, and four pixel units in the 2×2 pixel unit block may share one microlens, so that the two pixel units used to detect the moving target share one microlens. This can eliminate interference, and reduce false detection caused by noise introduced by the two pixel units using different microlenses.

Manner 3: A resolution of a lens used by the pixel array is lower than an optimal resolution of the lens corresponding to the pixel array.

The pixel array may be disposed on a photosensitive device. Based on a size of the photosensitive device and a quantity of pixel units disposed in the photosensitive device, an optimal resolution of a lens that matches the photosensitive device may be determined, and a lens whose resolution is lower than the optimal resolution is selected. For example, the pixel array uses a lens whose resolution is half of the optimal resolution. This can eliminate or reduce interference of the pixel to detect the moving target, improve accuracy of detecting the moving target.

The foregoing describes in detail the methods provided in embodiments of this application with reference to FIG. 2 to FIG. 14. The following describes in detail the detection apparatus provided in embodiments of this application.

In an implementation, the detection apparatus for performing the detection method provided in this embodiment of this application may be an image sensor.

For example, the image sensor may include but is not limited to the pixel array, a photosensitive circuit in which each pixel unit in the pixel array is located, a CDS unit connected to each photosensitive circuit, an analog amplifier unit, and an ADC unit, and the image sensor further includes the motion detection module. The motion detection module is configured to perform the motion detection method provided in embodiments of this application, to detect a moving target. For an example implementation, refer to the description in the foregoing method embodiments. For brevity, details are not described herein again.

In another implementation, the detection apparatus that performs the detection method provided in this embodiment of this application may be a control chip of the electronic device.

For example, the detection apparatus may be a system-on-chip of the electronic device, or referred to as a system on chip (SOC). The electronic device may include the pixel array, the photosensitive circuit, the CDS unit, the analog amplifier unit, the ADC unit, and the like. The electronic device may control exposure of the pixel array by using the SOC, the SOC may obtain luminance information of a pixel pair to generate motion information, and the SOC may further control, based on the motion information, the processing module to output image information. For an example implementation, refer to the description in the foregoing method embodiments. For brevity, details are not described herein again.

It should be understood that the foregoing two implementations are merely examples, and a specific form of the detection apparatus is not limited in this embodiment of this application. To implement functions in the methods provided in the foregoing embodiments of this application, the detection apparatus may include a hardware structure and/or a software module, to implement the foregoing functions by using the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

FIG. 15 is a schematic diagram of a structure of a detection apparatus 1500 according to an embodiment of this application. The detection apparatus 1500 includes a control module 1510 and a motion detection module 1520.

The control module 1510 is configured to control a first pixel unit to be exposed for first duration, and control a second pixel unit to be exposed for second duration, where the first duration is different from the second duration.

The motion detection module 1520 is configured to obtain first luminance information and second luminance information, where the first luminance information indicates luminance obtained by exposing the first pixel unit for the first duration, and the second luminance information indicates luminance obtained by exposing the second pixel unit for the second duration.

The motion detection module 1520 is further configured to output motion information based on the first luminance information and the second luminance information, where the motion information indicates whether a difference exists between the first luminance information and the second luminance information.

Optionally, in some implementations, the detection apparatus further includes a first conversion unit and a second conversion unit. The first conversion unit is configured to convert, into a first voltage value, a charge obtained by exposing the first pixel unit for the first duration, where a conversion gain of the first conversion unit is a first conversion gain, and the first luminance information is obtained based on the first voltage value, and a second conversion unit is configured to convert, into a second voltage value, a charge obtained by exposing the second pixel unit for the second duration, where a conversion gain of the second conversion unit is a second conversion gain, and the second luminance information is obtained based on the second voltage value.

A ratio of the first conversion gain to the second conversion gain is a first ratio, a ratio of the first duration to the second duration is a second ratio, and the first ratio is inversely proportional to the second ratio.

Optionally, in some implementations, the first pixel unit and the second pixel unit are two adjacent pixel units of a same color.

Optionally, in some implementations, a start moment of the first duration is the same as a start moment of the second duration, or an end moment of the first duration is the same as an end moment of the second duration.

Optionally, in some implementations, the motion detection module 1520 is further configured to output the motion information when a difference value between the first luminance information and the second luminance information is greater than a threshold, where the motion information indicates that the difference exists between the first luminance information and the second luminance information, or the motion detection module 1520 is further configured to output the motion information when a difference value between the first luminance information and the second luminance information is less than or equal to a threshold, where the motion information indicates that no difference exists between the first luminance information and the second luminance information.

Optionally, in some implementations, the first pixel unit and the second pixel unit share one microlens.

Optionally, in some implementations, the detection apparatus further includes a processing module. The control module 1510 is further configured to control exposure of a pixel array, where the pixel array includes the first pixel unit and the second pixel unit, and the processing module is configured to output first image information based on a first luminance information set, where the first luminance information set includes the first luminance information and the second luminance information.

Optionally, in some implementations, the control module 1510 is further configured to, when the motion information indicates that the difference exists between the first luminance information and the second luminance information, output first control information to the processing module, where the first control information indicates the processing module to output second image information corresponding to a pixel array, and the pixel array includes the first pixel unit and the second pixel unit, and the processing module is further configured to, in response to the first control information, output the second image information based on a second luminance information set corresponding to the pixel array.

Optionally, in some implementations, a pixel array includes a plurality of pixel pairs, each of the pixel pairs includes two pixel units, and the first pixel unit and the second pixel unit belong to one of the pixel pairs. The control module 1510 is further configured to control exposure of pixel units in the plurality of pixel pairs, where exposure duration of two pixel units in each of the pixel pairs is different, the motion detection module 1520 is further configured to obtain two pieces of luminance information of each of the plurality of pixel pairs, and output a plurality of pieces of motion information corresponding to the plurality of pixel pairs, and the control module 1510 is further configured to obtain the plurality of pieces of motion information, and determine, based on the plurality of pieces of motion information, a first pixel region corresponding to a moving target in the pixel array. The detection apparatus further includes a processing module. The control module 1510 is further configured to output second control information to the processing module, where the second control information indicates the processing module to output third image information corresponding to the first pixel region, and the processing module is configured to, in response to the second control information, output the third image information based on a third luminance information set corresponding to the first pixel region.

Optionally, in some implementations, the pixel array includes a plurality of pixel pair regions, one of the pixel pair regions includes at least two of the plurality of pixel pairs, and the motion detection module 1520 is further configured to determine original motion information of each of the pixel pairs based on the two pieces of luminance information of each of the plurality of pixel pairs, and filter a plurality of pieces of original motion information corresponding to the pixel pairs in one of the pixel pair regions, to obtain motion information corresponding to each pixel pair in one of the pixel pair regions.

FIG. 16 is a schematic diagram of a structure of an electronic device 1600 according to an embodiment of this application. The electronic device 1600 includes at least one processor 1610 and a memory 1620. The at least one processor 1610 is configured to execute a program or instructions stored in the memory, so that the electronic device performs the method in the embodiments shown in FIG. 4.

An embodiment of this application further provides a processor, including an input circuit, an output circuit, and a processing circuit. The processing circuit is configured to receive a signal through the input circuit, and transmit a signal through the output circuit, so that the processor performs the method in the embodiments shown in FIG. 4. It should be understood that the processing apparatus may be one or more chips.

According to the method provided in embodiments of this application, this application further provides a computer program product. The computer program product includes computer program code. When the computer program code is executed by one or more processors, an apparatus including the processor is enabled to perform the method in the embodiments shown in FIG. 4.

The technical solutions provided in this embodiment of this application may be fully or partially implemented through software, hardware, firmware, or any combination thereof. When software is used to implement the embodiments, all or some of the embodiments may be implemented in a form of a computer program product. The computer program product includes one or more computer instructions. When the computer program instructions are loaded and executed on the computer, the procedure or functions according to embodiments of this application are all or partially generated. The computer may be a general-purpose computer, a dedicated computer, a computer network, a network device, a terminal device, a core network device, a machine learning device, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device such as a server or a data center, integrating one or more usable media. The usable medium may be a magnetic medium (for example, a floppy disk, a hard disk, or a magnetic tape), an optical medium (for example, a DIGITAL VERSATILE DISC (DVD)), a semiconductor medium, or the like.

According to the method provided in embodiments of this application, this application further provides a computer-readable storage medium. The computer-readable storage medium stores program code. When the program code is run by one or more processors, an apparatus including the processor is enabled to perform the method in the embodiments shown in FIG. 4.

According to the method provided in embodiments of this application, this application further provides a system. The system includes the foregoing plurality of terminal apparatuses. The system may further include the foregoing one or more communication apparatuses.

In the several embodiments provided in this application, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

The foregoing descriptions are merely example implementations of this application, and are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An apparatus comprising:
a first pixel system;
a second pixel system; and
at least one processor configured to:
control the first pixel system to be exposed for a first duration;
control the second pixel system to be exposed for a second duration;
obtain first luminance information by exposing the first pixel system for the first duration, wherein the first luminance information indicates a first luminance;
obtain second luminance information by exposing the second pixel system for the second duration, wherein the second luminance information indicates a second luminance; and
output first motion information based on the first luminance information and the second luminance information,
wherein the first motion information indicates whether a difference exists between the first luminance information and the second luminance information.

2. The apparatus of claim 1, further comprising:
a first conversion system and configured to convert, using a first conversion gain, a first charge into a first voltage value, wherein the first charge is from exposing the first pixel system for the first duration, wherein the first luminance information is based on the first voltage value; and
a second conversion and configured to convert, using a second conversion gain, a second charge into a second voltage value, wherein the second charge is from exposing the second pixel system for the second duration, wherein the second luminance information is based on the second voltage value, wherein the first conversion gain to the second conversion gain has a first ratio, wherein the first duration to the second duration has a second ratio, and wherein the first ratio is inversely proportional to the second ratio.

3. The apparatus of claim 1, wherein the first pixel system and the second pixel system are two adjacent pixel systems of a same color.

4. The apparatus of claim 1, wherein a first start moment of the first duration is the same as a second start moment of the second duration, or wherein a first end moment of the first duration is the same as a second end moment of the second duration.

5. The apparatus of claim 1, wherein the processor is further configured to:
further output the first motion information when a difference value between the first luminance information and the second luminance information is greater than a threshold, wherein the first motion information indicates the difference exists; and
output second motion information when the difference value is less than or equal to the threshold, wherein the second motion information indicates no difference exists between the first luminance information and the second luminance information.

6. The apparatus of claim 1, wherein the first pixel system shares one microlens with the second pixel system.

7. The apparatus of claim 1, further comprising a pixel array comprising the first pixel system and the second pixel system, wherein the at least one processor is further configured to:
control exposure of the pixel array; and
output image information based on a luminance information set, wherein the luminance information set comprises the first luminance information and the second luminance information.

8. The apparatus of claim 1, further comprising a pixel array comprising the first pixel system and the second pixel system, wherein the at least one processor is further configured to:
output control information when the first motion information indicates the difference exists; and
output, in response to the control information, image information corresponding to the pixel array based on a luminance information set corresponding to the pixel array.

9. The apparatus of claim 1, further comprising a pixel array comprising pixel pairs, wherein each of the pixel pairs comprises two pixel systems, wherein the first pixel system and the second pixel system are of one of the pixel pairs, and wherein the at least one processor is further configured to:
control exposure of pixel systems in the pixel pairs, wherein an exposure duration of the two pixel systems in each of the pixel pairs is different;
obtain two pieces of third luminance information of each of the pixel pairs;
obtain pieces of second motion information corresponding to the pixel pairs;
determine, based on the pieces of second motion information, a first pixel region corresponding to a moving target in the pixel array;
obtain control information to output image information corresponding to the first pixel region; and
output, in response to the control information, the image information based on a luminance information set corresponding to the first pixel region.

10. The apparatus of claim 9, wherein the pixel array further comprises pixel pair regions, wherein one of the pixel pair regions comprises at least two of the pixel pairs, and wherein the at least one processor is further configured to:
determine original motion information of each of the pixel pairs based on the two pieces of the third luminance information; and
filter pieces of original motion information corresponding to the at least two of the pixel pairs to obtain third motion information corresponding to each pixel pair in the one of the pixel pair regions.

11. A method comprising:
controlling a first pixel system to be exposed for a first duration;
controlling a second pixel system to be exposed for a second duration, wherein the first duration is different from the second duration;
obtaining first luminance information by exposing the first pixel system for the first duration, wherein the first luminance information indicates a first luminance;
obtaining second luminance information by exposing the second pixel system for the second duration, wherein the second luminance information indicates a second luminance; and
outputting first motion information based on the first luminance information and the second luminance information,
wherein the first motion information indicates whether a difference exists between the first luminance information and the second luminance information.

12. The method of claim 11, further comprising:
controlling a first conversion system to convert, using a first conversion gain, a first charge into a first voltage value, wherein the first charge is from exposing the first pixel system for the first duration;
obtaining the first luminance information based on the first voltage value;
controlling a second conversion system to convert, using a second conversion gain, a second charge into a second voltage value by exposing the second pixel system for the second duration; and
obtaining the second luminance information based on the second voltage value, wherein the first conversion gain to the second conversion gain has a first ratio, wherein the first duration to the second duration has a second ratio, and wherein the first ratio is inversely proportional to the second ratio.

13. The method of claim 11, wherein the first pixel system and the second pixel system are two adjacent pixel systems of a same color, and wherein the first pixel system shares one microlens with the second pixel system.

14. The method of claim 11, wherein a first start moment of the first duration is the same as a second start moment of the second duration, or wherein a first end moment of the first duration is the same as a second end moment of the second duration.

15. The method of claim 11, further comprising:
generating the first motion information when a difference value between the first luminance information and the second luminance information is greater than a threshold, wherein the first motion information indicates the difference exists; and
generating second motion information when the difference value is less than or equal to the threshold, wherein the second motion information indicates that no difference exists between the first luminance information and the second luminance information.

16. The method of claim 11, further comprising:
controlling exposure of a pixel array, wherein the pixel array comprises the first pixel system and the second pixel system; and
outputting image information based on a luminance information set corresponding to the pixel array, wherein the luminance information set comprises the first luminance information and the second luminance information.

17. The method of claim 11, wherein when the first motion information indicates that the difference exists between the first luminance information and the second luminance information, the method further comprises:
obtaining a luminance information set corresponding to a pixel array; and
outputting image information based on the luminance information set.

18. The method of claim 11, further comprising:
controlling exposure of pixel systems in pixel pairs of a pixel array, wherein each of the pixel pairs comprises two pixel systems, wherein the first pixel system and the second pixel system are of one of the pixel pairs, wherein exposure duration of the two pixel systems in each of the pixel pairs is different;
obtaining two pieces of third luminance information of each of the pixel pairs;
generating pieces of second motion information corresponding to the pixel pairs;
determining, based on the pieces of second motion information, a first pixel region corresponding to a moving target in the pixel array;
controlling exposure of a third pixel system in the first pixel region; and
outputting image information based on a luminance information set corresponding to the first pixel region.

19. The method of claim 18, wherein the pixel array comprises pixel pair regions, wherein one of the pixel pair regions comprises at least two of the pixel pairs, and wherein the method further comprises:
determining original motion information of each of the pixel pairs based on the two pieces of the third luminance information; and
filtering pieces of original motion information corresponding to the at least two of the pixel pairs to obtain third motion information corresponding to each pixel pair in the one of the pixel pair regions.

20. A computer program product comprising computer-executable instructions that are stored on a non-transitory computer-readable storage medium and that, when executed by at least one processor, cause an apparatus to:
controlling a first pixel system to be exposed for a first duration;
controlling a second pixel system to be exposed for a second duration, wherein the first duration is different from the second duration;
obtaining first luminance information by exposing the first pixel system for the first duration, wherein the first luminance information indicates a first luminance;
obtaining second luminance information by exposing the second pixel system for the second duration, wherein the second luminance information indicates a second luminance; and
generating motion information based on the first luminance information and the second luminance information,
wherein the motion information indicates whether a difference exists between the first luminance information and the second luminance information.
